(19) United States
(12) Patent Application Publication
(10) Pub. No.: US 2023/0249732 A1
(43) Pub. Date: Aug. 10, 2023

(54) WALKING TYPE ELECTRIC TRANSPORTER

(71) Applicant: Kawakami Sangyo Co., Ltd., Tokyo (JP)

(72) Inventors: Yuya KATO, Kanagawa (JP); Takashi MOCHIZUKI, Kanagawa (JP); Koji SATO, Tokyo (JP); Atsushi YOKOI, Tokyo (JP); Akiko HATA, Tokyo (JP); Keisuke MOMMA, Tokyo (JP)

(21) Appl. No.: 18/108,206

(22) Filed: Feb. 10, 2023

(30) Foreign Application Priority Data
Feb. 10, 2022 (JP) 2022-019979

(51) Int. Cl. B62B 5/00; B62B 3/00; B62B 5/06; B60L 50/60

(52) U.S. Cl. CPC B62B 5/0053; B62B 3/00; B62B 5/06; B60L 50/66

(57) ABSTRACT

The present disclosure provides a walking type electric transporter capable of being continuously used for a long time while preventing breakage of a storage battery due to a collision of cargo. A storage battery is accommodated in a box-shaped battery casing, the battery casing is detachably attached to a transporter main body portion, and the battery casing holds the storage battery while having spaces in such a manner that an upper portion and a front portion in an interior and an upper surface and a front surface of the storage battery are respectively separated from each other.

### BACKGROUND OF THE INVENTION

### Field of the Invention

The present invention relates to a walking type electric transporter that moves a trolley by operation of a worker.

### Description of the Related Art

In a factory, a warehouse, a logistics center, etc., a worker pushes and moves a roll pallet, etc. on which articles such as parts and products are loaded to a desired position in general. In recent years, along with a downsizing and a lower price of a large-capacity battery, a device capable of supporting works that have been manually performed with an electric drive means became radically spread, and also in the field of logistics, etc., an electric transporter capable of towing or pushing back a roll pallet appeared (for example, JP 2020-23288 A (Page 4, FIG. 2)).

The electric transporter shown in JP 2020-23288 A is a walking type electric transporter including a transporter main body portion which includes a drive portion capable of driving wheels with electric power, a standing portion which stands upward from the transporter main body portion and includes a handle portion to be gripped by a worker at an upper end, and a storage battery that supplies the electric power to the drive portion. By operating a throttle provided in the handle portion in a state where an engagement portion provided in the transporter main body portion is engaged with a roll pallet, etc., the worker can tow or push back to move the roll pallet by travel of the transporter main body portion only by walking in accordance with the travel of the walking type electric transporter. Thus, it is possible to reduce human burden in article conveying work to a large extent.

As the one having a structure similar to the walking type electric transporter, there is a walking type management machine to be used in agricultural work although both the field and use are different (for example, JP 2005-348617 A (Page 4, FIG. 5)). This walking type management machine is configured in such a manner that a battery pack is attachable to and detachable from a machine main body portion, and by detaching the battery pack whose remaining charge is low and replacing with a battery pack whose remaining charge is high, it is possible to continuously use the walking type management machine for a long time. Both the walking type electric transporter to be operated by the walking worker and the walking type management machine commonly have a structure in which the standing portion stands obliquely rearward from the transporter/machine main body portion and the battery is supported by a front portion of the standing portion in order not to obstruct a walk.

Although not particularly described in JP 2020-23288 A, many walking type electric transporters adopt a structure in which a battery is fixed to a transporter main body portion. In a case where a remaining charge of the battery is low, there is a need for parking the entire walking type electric transporter at a charging station, and a continuous use time is short. Thus, application of the technique in which the battery pack is attachable and detachable is preferable as in JP 2005-348617 A. However, the walking type electric transporter is utilized in an environment where cargo shifting, etc. may occur in relation to movement of heavy articles. Thus, there is a possibility that cargo collides with the battery supported by the front portion of the standing portion and the battery is broken.

The present invention is made in view of such a problem, and an object thereof is to provide a walking type electric transporter capable of being continuously used for a long time while preventing breakage of a storage battery due to a collision of cargo.

### SUMMARY OF THE INVENTION

In order to solve the above problem, a waking type electric transporter according to the present invention is a walking type electric transporter including a handle portion to be gripped by a worker, and a drive portion capable of driving wheels with electric power, the walking type electric transporter to be coupled to a trolley on which cargo is mounted to be capable of electrically towing or pushing back, the walking type electric transporter further including a transporter main body portion including the drive portion and the wheels, a standing portion standing upward from the transporter main body portion and including the handle portion at an upper end, and a storage battery that supplies the electric power to the drive portion, wherein the storage battery is accommodated in a box-shaped battery casing, and the battery casing is detachably attached to the transporter main body portion, and wherein the battery casing holds the storage battery while having a space in such a manner that an upper portion and a front portion in an interior and an upper surface and a front surface of the storage battery are respectively separated from each other According to the aforesaid feature of the present invention, the battery casing in which the storage battery is accommodated is detachably attached to the transporter main body portion. Thus, it is possible to easily exchange the storage battery upon battery depletion or aging deterioration. For example, by detaching the battery casing in which the storage battery whose remaining charge is low is accommodated and replacing with a battery casing in which a storage battery whose remaining charge is high is accommodated, it is possible to continuously use the walking type electric transporter for a long time. Moreover, in a case where cargo shifting occurs, etc., there is a possibility that a serious accident such as firing from the storage battery by breakage due to a collision of cargo is caused. However, the storage battery is held while having the space in such a manner that the upper surface and the front surface are respectively separated in the interior of the battery casing. Thus, shock resistance against the collision of cargo is enhanced, and it is possible to effectively prevent the breakage.

It may be preferable that the transporter main body portion includes a case in which the drive portion is accommodated, and a surrounding portion provided in a periphery while being separated from the case, and the battery casing is supported by the surrounding portion. According to this preferable configuration, a load applied to the battery casing at the time of a collision of cargo, etc. is absorbed by elastic deformation of the surrounding portion, and it is possible to prevent breakage of the battery casing itself more.

It may be preferable that a mounting plate having a shape along a shape of a lower portion of the battery casing is attached on the upper side of the surrounding portion, and the battery casing is supported in a state of concavo-convex engagement with the mounting plate. According to this preferable configuration, relative movement in the horizontal direction of the battery casing and the mounting plate is regulated, and it is possible to prevent dropping off of the battery casing and also attach the battery casing always at a fixed position of the transporter main body portion.

It may be preferable that on the back surface side of the battery casing, guiding convex streaks placed across the standing portion of the transporter main body portion on the left and right sides are formed while being separated from each other in the left and right direction. According to this preferable configuration, it is possible to prevent oscillation of the battery casing in the left and right direction with respect to the transporter main body portion, and by guiding the guiding convex streaks to the standing portion at the time of attachment, it is also possible to lead the battery casing to the fixed position of the transporter main body portion.

It may be preferable that the battery casing holds the storage battery while having a space in such a manner that both side portions in the interior and both side surfaces of the storage battery are respectively separated from each other. According to this preferable configuration, it is possible to reduce an influence on the storage battery irrespective of the direction of an external force applied to the battery casing, and enhance the shock resistance.

It may be preferable that the battery casing is configured into a box shape by a front plate, a rear plate, and an endless tubular body nipped by the front plate and the rear plate. According to this preferable configuration, the tubular body can obtain high strength with respect to a load in the front to rear direction.

It may be preferable that the walking type electric transporter has a bent groove portion in an upper portion of a front surface of the front plate of the battery casing, and the groove portion has a shape in which a central portion in the left and right direction is convex downward. According to this preferable configuration, a load applied to the battery casing at the time of the collision of cargo, etc. is absorbed by elastic deformation of the front plate originating at the groove portion, and it is possible to prevent the breakage of the battery casing itself more.

It may be preferable that the tubular body is corrugated. According to this preferable configuration, by increasing a contact area between the front plate and the tubular body, an external force applied to the front plate is easily transmitted to the tubular body, and it is possible to enhance the shock resistance of the battery casing.

### BRIEF DESCRIPTION OF THE DRAWINGS

FIG. 1 is a perspective view showing a walking type electric transporter according to an embodiment of the present invention.

FIG. 2 is a side view of the walking type electric transporter.

FIG. 3 is a perspective view of the walking type electric transporter in which a battery casing is expressed by a chain line.

FIG. 4 is a side view of the walking type electric transporter in which the battery casing and a wheel on the near side are not shown.

FIG. 5 is an exploded perspective view of the battery casing.

FIG. 6 is a front view of the battery casing in which a front plate is not shown.

FIGS. 7A and 7B are front views showing a relationship between the battery casing and a mounting plate.

FIGS. 8A and 8B are perspective views showing the relationship between the battery casing and the mounting plate.

FIG. 9 is a perspective view showing the back surface side of the battery casing.

FIGS. 10A and 10B are side views showing a mode in which a hand screw of a standing portion and a hook of the battery casing are engaged with each other.

### DESCRIPTION OF THE PREFERRED EMBODIMENTS

A mode for carrying out a walking type electric transporter according to the present invention will be described below based on an embodiment.

### Embodiment

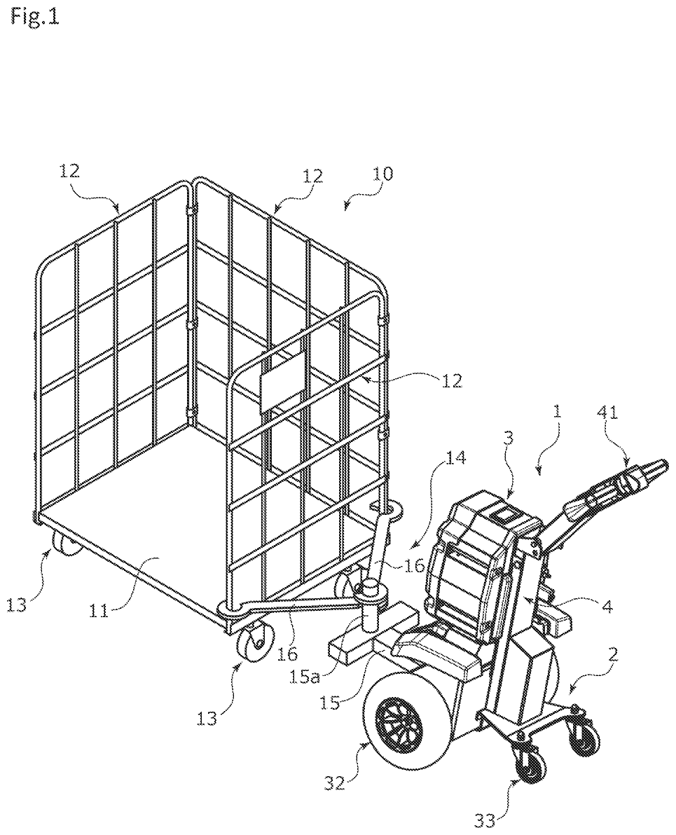

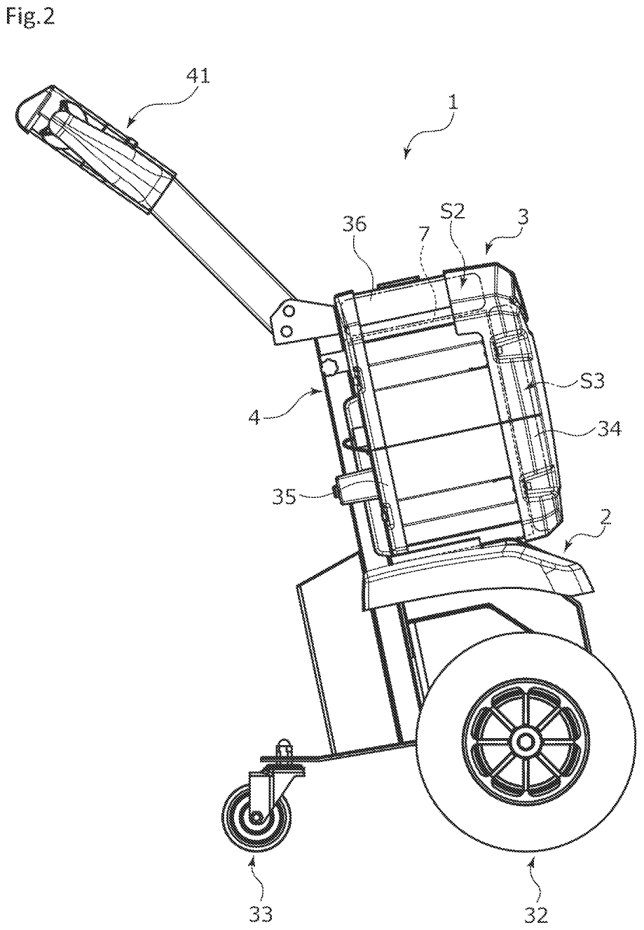

A walking type electric transporter according to an embodiment of the present invention will be described with reference to FIGS. 1 to 10B. Hereinafter, the right side of the paper plane of FIG. 2 will be referred to as the front side of the walking type electric transporter, and the left side of the paper plane of FIG. 2 will be described as the rear side of the walking type electric transporter.

As shown in FIG. 1, a walking type electric transporter (hereinafter, simply referred to as the “transporter”) 1 is utilized at the time of traveling on a floor surface and transporting a roll pallet 10 (trolley) in a factory, a warehouse, a logistics center, etc. The roll pallet 10 in the present embodiment is configured by a bottom plate 11 formed in a rectangular shape in a plan view, on which articles can be loaded, grid-shaped panels 12 provided to stand along three sides of the bottom plate 11, and casters 13 respectively provided at front and rear ends of a lower end. Articles to be loaded can be brought in and out from one side where no panel 12 is provided to stand.

The transporter 1 is coupled to the roll pallet 10 by using a coupling tool 14 and used. The coupling tool 14 includes a coupling bar 15 provided to extend on the front surface side of a transporter main body portion 2 in the transporter 1, a coupling shaft 15a provided to stand upward at a front end of the coupling bar 15, and arms 16, 16 whose one ends are pivotably supported by the coupling shaft 15a. Hook portions of the other ends of the arms 16, 16 are engaged with a portion of the roll pallet 10 on the rear side in the traveling direction, and the transporter 1 and the roll pallet 10 are coupled to each other. It is noted that the coupling tool 14 is not shown in FIG. 2 and the following figures.

As shown in FIG. 2, the transporter 1 is mainly configured by the transporter main body portion 2 capable of traveling on the floor surface, a standing portion 4 extending obliquely rearward from the transporter main body portion 2, and a battery casing 3 installed on the upper side of the transporter main body portion 2 and on the front side of the standing portion 4.

In the transporter main body portion 2, two drive wheels 32 are provided on the left and right sides in a portion of the transporter main body portion 2 on the front side, and two casters 33 are provided on the left and right sides in a portion of the transporter main body portion 2 on the rear side.

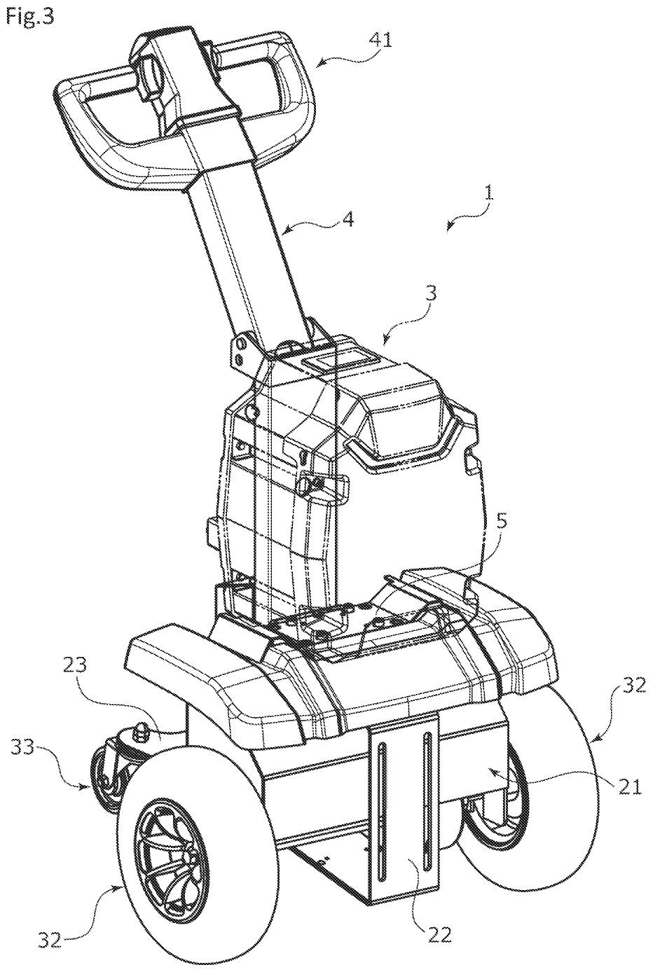

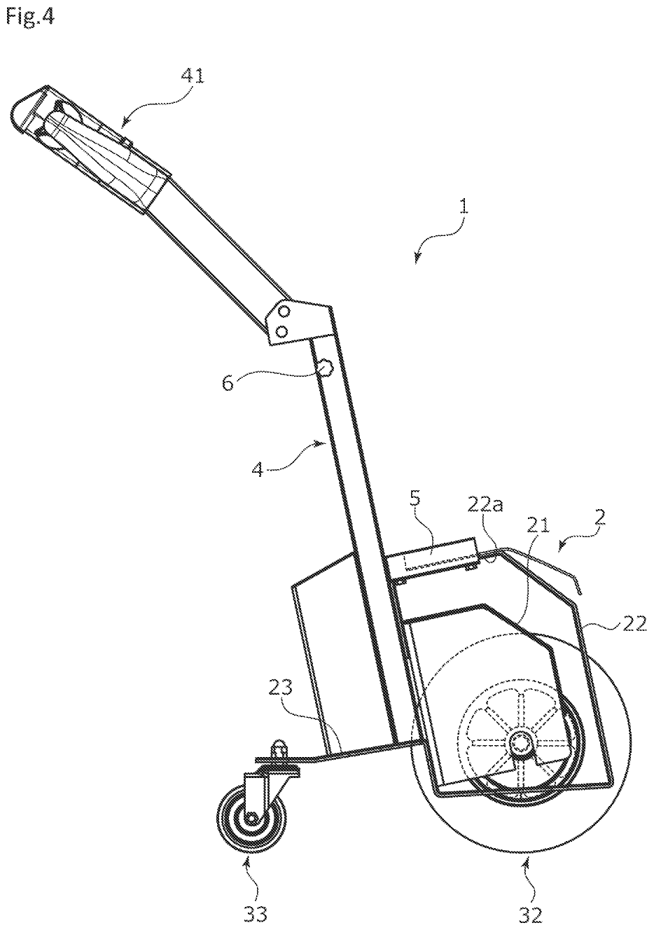

As shown in FIGS. 3 and 4, the transporter main body portion 2 has a box-shaped metal case 21, a surrounding portion 22 configured by bending a metal plate to surround the case 21 in the vertical direction, and a flat plate portion 23 extending on the rear side of the case 21. The flat plate portion 23 is configured integrally with the surrounding portion 22 by the metal plate. Moreover, although not shown in the figure, a drive motor, a shaft, and a control board serving as drive means that drive the drive wheels 32 are built in the case 21.

In the standing portion 4, a lower end is welded and fixed to the flat plate portion 23, and a handle portion 41 is provided in an upper end. By operating a throttle provided in the handle portion 41 (although not described in detail) in a state of gripping the handle portion 41, a worker can drive the drive wheels 32, and by walking in accordance with travel of the transporter 1, transport the roll pallet 10 with an extremely small force. Moreover, hand screws 6 to be described later are screwed into an upper side portion of the standing portion 4.

As shown in FIG. 4, the surrounding portion 22 is welded and fixed to the standing portion 4, and provided in a periphery while being separated from an upper portion, a lower portion, and a front portion of the case 21. Moreover, an upper surface portion 22a of the surrounding portion 22 is perpendicular to the standing portion 4, and a mounting plate 5 to be described later is fixed to this upper surface portion 22a.

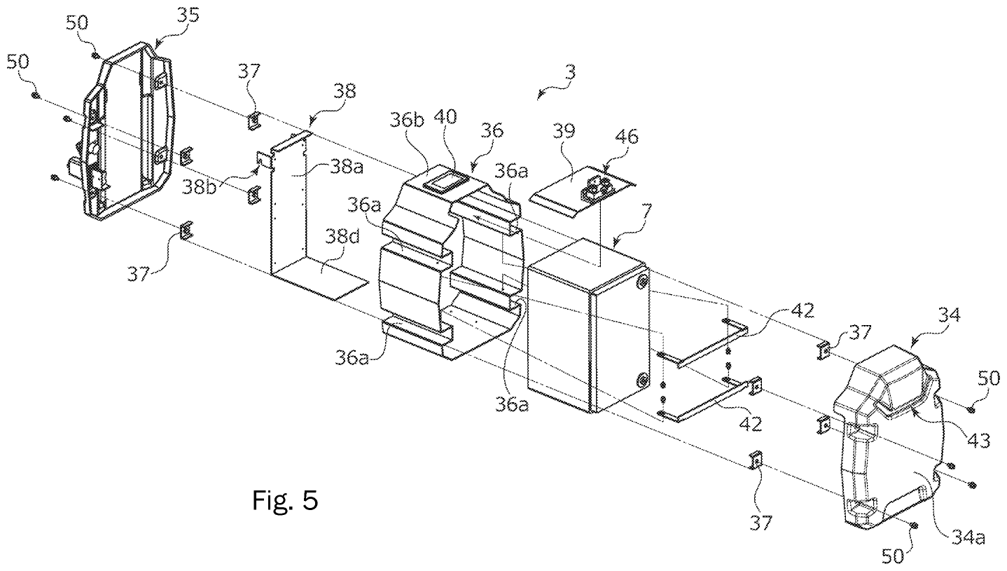

As shown in FIG. 5, a storage battery 7 that supplies electric power to the drive motor is accommodated in the box-shaped battery casing 3. The battery casing 3 is configured into a box shape by a front plate 34, a rear plate 35, and an endless tubular body 36 nipped by the front plate 34 and the rear plate 35 from the front and the rear sides. The front plate 34, the rear plate 35, and the tubular body 36 are made of synthetic resin having elasticity.

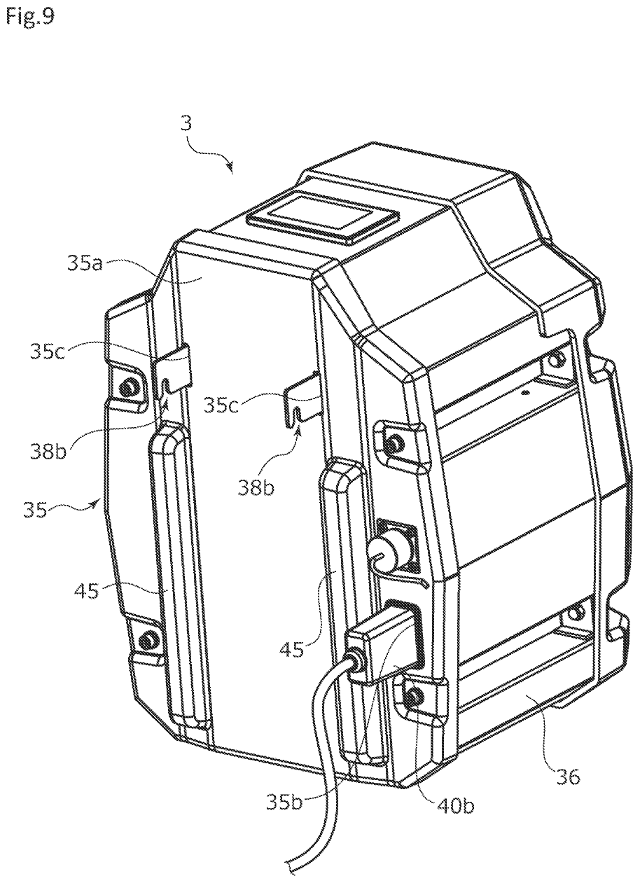

A through hole 35b is formed in a back surface portion 35a of the rear plate 35 of the battery casing 3, and a connector 40b of a power cable extending from the transporter main body portion 2 in an exterior of the battery casing 3 is inserted through the through hole 35b and connected to a connector (not shown) of the storage battery 7 in an interior of the battery casing 3 (see FIG. 9).

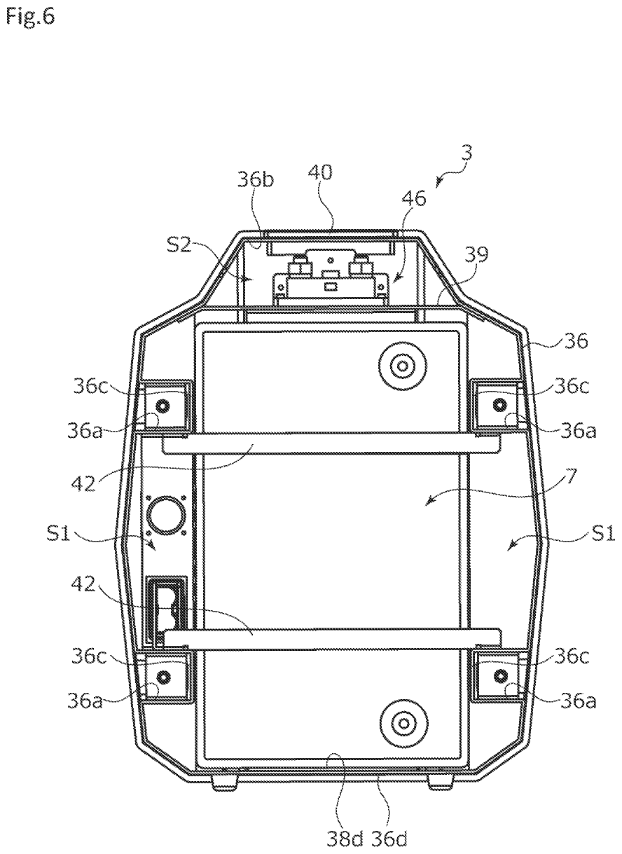

As shown in FIGS. 5 and 6, the battery casing 3 is formed to have a left and right width in a central portion in the up and down direction in such a manner that left and right widths of an upper portion and a lower portion are smaller than the central portion. Concave portions 36a recessed inward are respectively formed on both the left and right sides and on the upper and lower sides, so that the tubular body 36 is corrugated as a whole. Upper and lower surfaces of the concave portions 36a are formed to be parallel to each other, and U-shaped base members 37 are secured to the upper and lower surfaces of the concave portions 36a.

The base members 37 are respectively fixed to front and rear end portions of all the concave portions 36a, and hole portions passing through in the front to rear direction are formed. The front plate 34 and the rear plate 35 have holes at positions corresponding to these hole portions. By fastening screws 50 from the front to rear direction, the front plate 34, the rear plate 35, and the tubular body 36 are integrally fixed to each other.

Upper and lower outside surfaces of a U-shaped strength material 38 are respectively fixed to upper and lower inside surfaces of the tubular body 36. An outer surface of a back surface portion 38a of the strength material 38 is abutted with an inner surface of the rear plate 35, and a plurality of rubber feet (not shown) are attached to an inner surface of the back surface portion 38a, so that a backlash of the storage battery 7 installed inside the tubular body 36 is prevented, and vibration at the time of travel of the transporter 1 does not easily act on the storage battery 7 which inclines and leans on the strength material 38.

Moreover, as shown in FIGS. 5 and 6, a display 40 which is visible from the outside is attached to an upper surface portion 36b of the tubular body 36, and an electronic device 46 that displays status information such as a remaining charge of the storage battery 7 and a charging time on this display 40 is arranged inside the tubular body 36. In detail, the electronic device 46 is arranged in a space between a plate body 39 fixed on the upper side inside the tubular body 36 and the upper surface portion 36b of the tubular body 36.

As described above, the battery casing 3 in which the storage battery 7 is accommodated is detachably attached to the transporter main body portion 2. Thus, it is possible to easily exchange the storage battery 7 upon battery depletion or aging deterioration. For example, by detaching the battery casing 3 in which the storage battery 7 whose remaining charge is low is accommodated and replacing with a battery casing 3 in which a storage battery 7 whose remaining charge is high is accommodated, it is possible to continuously use the transporter 1 for a long time.

Moreover, regarding the upper and lower concave portions 36a of the battery casing 3, left-right positions of inside portions 36c match with each other in the up and down direction, and the storage battery 7 is arranged between the concave portions 36a of the tubular body 36 and movement in the left and right direction is regulated. In other words, portions of the tubular body 36 other than the concave portions 36a in both left and right side portions are separated from both left and right side portions of the storage battery 7, and spaces S1 are formed between these. Thus, upon a collision of cargo with the battery casing 3, etc. due to occurrence of cargo shifting, etc., an external force does not directly act on the storage battery 7, and shock resistance is excellent.

Moreover, guard members 42 are respectively provided to bridge the left and right concave portions 36a on the front side of the inside of the tubular body 36, and movement of the storage battery 7 in the front to rear direction is regulated between the strength material 38 and the guard members 42. The front plate 34 configuring a front surface portion of the battery casing 3 has a shape expanded forward. A front surface of the storage battery 7 is held by the guard members 42 and separated from the front plate 34, and a space S3 (see FIG. 2) is formed between these. Thus, upon the collision of cargo, etc., the external force does not directly act on the storage battery 7, and the shock resistance is excellent.

Moreover, movement of the storage battery 7 in the up and down direction is regulated between the plate body 39 on the upper side inside the tubular body 36, and a lower surface portion 36d of the tubular body 36 and a lower surface portion 38d of the strength material 38 (see FIG. 5). In other words, an upper portion of the storage battery 7 and the upper surface portion 36b of the tubular body 36 are separated from each other, and a space S2 (see FIGS. 2 and 6) exists between the plate body 39 and the upper surface portion 36b of the tubular body 36. Thus, upon the collision of cargo, etc., the external force does not directly act on the storage battery 7, and the shock resistance is excellent.

Moreover, in an upper portion of an outer surface 34a of the front plate 34 of the battery casing 3, a groove portion 43 bent in such a manner that a central portion in the left and right direction is convex downward is formed, and upper and lower portions of the front plate 34 are easily elastically deformed across this groove portion 43. Therefore, since a front upper portion of the battery casing 3 with which a possibility of the collision of cargo is high at the time of cargo shifting can be elastically deformed, a shock is absorbed and it is possible to effectively prevent breakage of the battery casing 3 and the storage battery 7 in the interior.

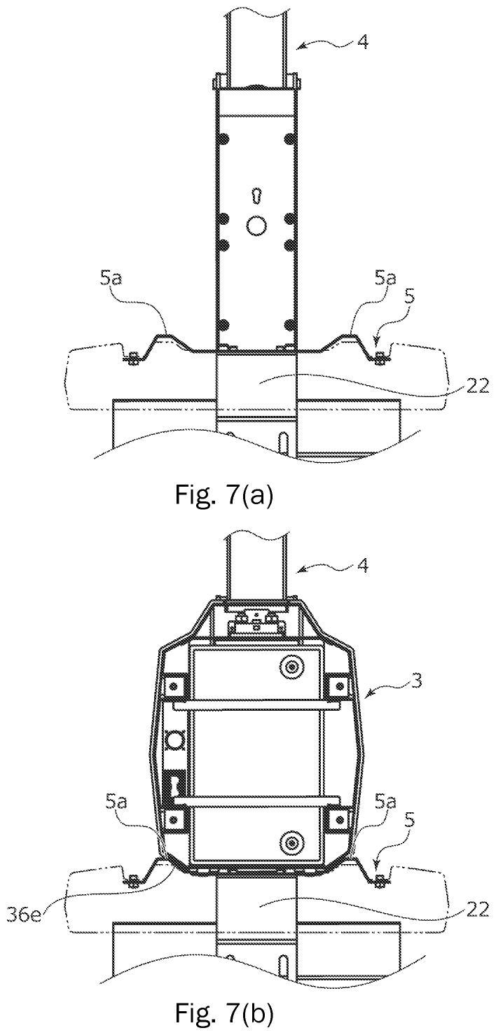

As shown in FIG. 7B, the battery casing 3 is mounted and held on the mounting plate 5 of the transporter main body portion 2. The mounting plate 5 is formed in a concave shape in a front view having convex portions 5a which project upward in left and right end portions, and a lower end portion of the battery casing 3 is formed in a convex shape having a narrow width. By concavo-convex engaging the mounting plate 5 and the lower end portion of the battery casing 3 with each other, movement of the battery casing 3 in the left and right direction is regulated. Moreover, the convex portions 5a in the left and right end portions of the mounting plate 5 are tapered, and the lower end portion of the battery casing 3, that is, the lower surface portion 36d of the tubular body 36 has corresponding inclined surfaces 36e on the left and right sides. Thus, at the time of mounting the battery casing 3 which is relatively heavy on the mounting plate 5, the battery casing 3 is guided to a relatively precise position, and workability is excellent.

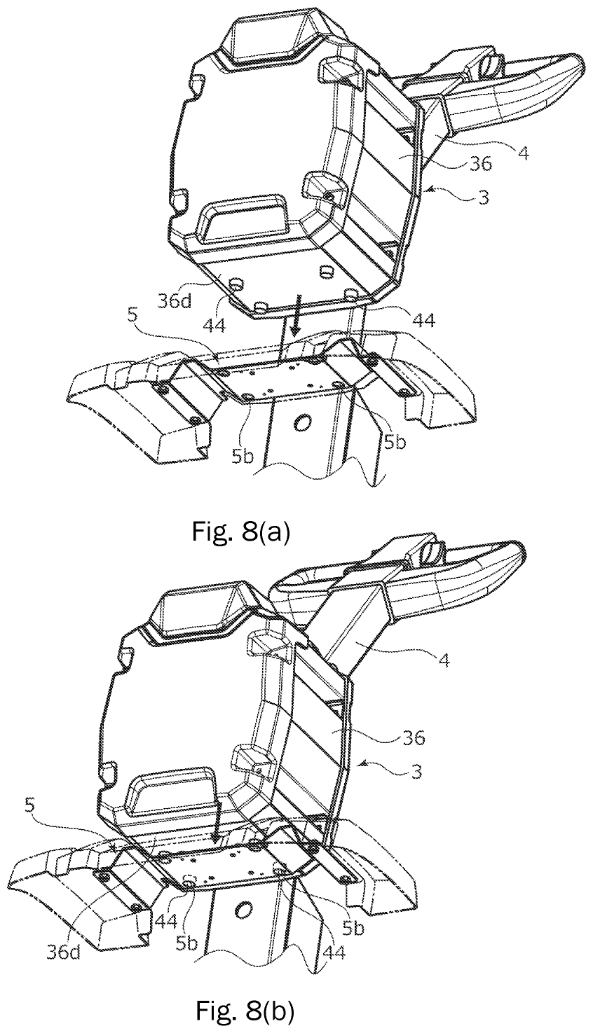

As shown in FIG. 8A, at four corners of the lower end portion of the battery casing 3, that is, the lower surface portion 36d of the tubular body 36, resin foot portions 44 to be grounded at the time of mounting the battery casing 3 directly on the floor, etc. are provided. Moreover, holes 5b with which the foot portions 44 are respectively engaged from the upper side are provided in the mounting plate 5. By engaging the foot portions 44 with the holes 5b, movements of the battery casing 3 in the front to rear direction and in the left and right direction are regulated.

Moreover, as shown in FIG. 9, in the back surface portion 35a of the rear plate 35 of the battery casing 3, guiding convex streaks 45 extending in the up and down direction are formed and expanded while being separated from each other in the left and right direction. These guiding convex streaks 45 are arranged to respectively oppose left and right side surfaces of the standing portion 4, and the movement of the battery casing 3 in the left and right direction with respect to the standing portion 4 is regulated.

Moreover, as shown in FIGS. 5 and 9, on the back surface side of the strength material 38, downward hooks 38b are provided to extend while being separated from each other in the left and right direction. These hooks 38b are exposed from slits 35c formed in the rear plate 35 of the battery casing 3 to an exterior of the battery casing 3.

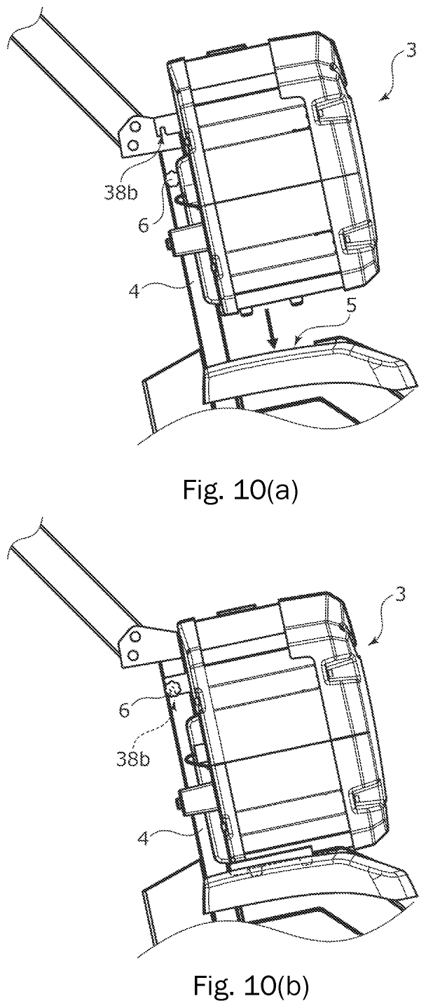

As shown in FIG. 10, to left and right side surfaces of the upper side portion of the standing portion 4, the hand screws 6 are respectively screwed, and along with mounting of the battery casing 3 on the mounting plate 5, by engaging screw shank portions (not shown) of the hand screws 6 with the hooks 38b from the upper side, movement of the battery casing 3 in the front direction is regulated. In addition, the hand screws 6 are stepped having larger diameter portions than the screw shank portions on the head portion side. By screwing the hand screws 6 in a state of engagement with the hooks 38b, the plate-shaped hooks 38b are nipped between the larger diameter portions of the hand screws 6 and the left and right side surfaces of the standing portion 4, and movement of the battery casing 3 in the upper direction is suppressed.

Moreover, the storage battery 7 and the transporter main body portion 2 are configured to be connected by the power cable. Thus, even in a case where the battery casing 3 is moved with respect to the transporter main body portion 2 due to the time of the collision of cargo, etc. by any chance, disconnection associated with breakage does not easily occur between the storage battery 7 and the transporter main body portion 2.

The embodiment of the present invention is described above with the drawings. However, specific configurations are not limited to the embodiment but the present invention includes changes and additions within the range not departing from the scope of the present invention.

For example, the trolley to be conveyed by the transporter 1 is not limited to the roll pallet but may be, for example, a wheeled platform, a hand trolley, a shipping container, etc. as long as it has wheels.

Moreover, in the above embodiment, the battery casing 3 is mainly configured by the front plate 34, the rear plate 35, and the tubular body 36, and by removing the screws 50, it is possible to access the storage battery 7 in the interior and a maintenance property is excellent. However, the present invention is not limited to this but the battery casing may be formed by an integrated synthetic resin or metal box.

Moreover, in the above embodiment, the configuration that the mounting plate 5 is formed in a concave shape in a front view having the convex portions 5a which project upward in the left and right end portions, the lower end portion of the battery casing 3 is formed in a convex shape having a narrow width, and the mounting plate 5 and the lower end portion of the battery casing 3 are concavo-convex engaged with each other is described. However, the present invention is not limited to this but the shape of the mounting plate side may be a convex shape in a front view and the lower end portion of the battery casing 3 may be formed in a concave shape.

Moreover, the tubular body 36 may be formed in an endless shape by securing a plurality of plate bodies to each other.

Moreover, in the above embodiment, the configuration that the movement of the storage battery 7 in the up and down direction is regulated between the plate body 39 on the upper side inside the tubular body 36, and the lower surface portion 36d of the tubular body 36 and the lower surface portion 38d of the strength material 38 (see FIG. 5) is described. However, the present invention is not limited to this but a configuration that, for example, a hat-shaped member projecting downward is fixed on the upper side in the tubular body 36 in place of the plate body 39 and the movement in the upper direction is regulated by this hat-shaped member may be adopted.

Moreover, the space S3 on the front side of the storage battery 7 in the interior of the battery casing 3, the space S2 on the upper side, and the spaces S1 on the left and right sides are not limited to the configuration described above. As long as forward, upward, leftward, and rightward movements of the storage battery 7 are respectively regulated in such a manner that the spaces S3, S2, S1 are formed inside the battery casing 3, any configuration may be adopted. For example, by attaching guard members respectively projecting left-inward and right-inward to both left and right inner surfaces of the battery casing 3, both left and right ends of the storage battery 7 are separated from both left and right inner surfaces of the tubular body, and it is also possible to form spaces S1 between these.

Moreover, a configuration to suppress the movement of the battery casing 3 in the upper direction is not limited to the configuration of using the hand screws 6 and the hooks 38b as in the above embodiment. For example, a concave portion may be formed in the upper portion of the battery casing 3 and a claw member to be engaged with this concave portion may be provided in the standing portion 4.

Moreover, as the configuration to suppress the movement of the battery casing 3 in the upper direction, for example, an upward claw portion may be provided in the standing portion 4, a hook portion to be engaged with this claw portion may be provided in the upper portion of the battery casing 3, and a so-called draw latch configured by the claw portion and the hook portion may be used.

Moreover, as the configuration to suppress the movement of the battery casing 3 in the upper direction, a configuration that, for example, a concave portion is provided in the standing portion 4, a hook portion to be engaged with this concave portion is provided in the upper portion of the battery casing 3, and the hook portion is biased upward by a biasing means may be adopted.

Moreover, a configuration to regulate the movement of the battery casing 3 in the left and right direction with respect to the standing portion 4 is not limited to the structure in which the convex portions 5a projecting upward are formed in the left and right end portions of the mounting plate 5 and the mounting plate 5 and the lower end portion of the battery casing 3 are concavo-convex engaged with each other as in the above embodiment. For example, with a configuration that concave grooves extending in the up and down direction are formed on the left and right sides of the battery casing 3, bar portions standing upward are formed in the left and right end portions of the mounting plate 5, and the concave grooves are engaged with the bar portions from the upper side, it is also possible to regulate the movement in the front to rear direction in addition to the left and right direction.

Moreover, with a configuration that a concave groove extending in the up and down direction is formed in front of the front surface side of the battery casing 3, a guard portion standing upward is formed on the front surface side of the mounting plate 5, and the concave groove is engaged with the guard portion from the upper side, it is also possible to regulate the movement in the front to rear direction in addition to the left and right direction. It is noted that a configuration that a concave groove is also formed on the back surface side in addition to the front surface side of the battery casing 3, guard portions are formed on the front surface side and the back surface side of the mounting plate 5, and the battery casing 3 is nipped from the front and rear sides may be adopted, or a function to suppress the movement of the battery casing 3 in the up and down direction may be added by providing a ball plunger in the guard portion and providing a concave portion to be engaged with the ball plunger on the concave groove side.

Moreover, with a configuration that a slit-shaped hole portion is formed in a bottom portion of the battery casing 3, a plate portion standing upward is formed in the mounting plate 5, and the hole portion is engaged with the plate portion from the upper side, it is also possible to regulate the movement in the front to rear direction in addition to the left and right direction.

Moreover, with a configuration that the lower end portion of the battery casing 3 and an upper surface of the mounting plate 5 are magnetically attachable to each other, a function to suppress the movement of the battery casing 3 in the up and down direction may be added.

What is claimed is:

1. A walking type electric transporter comprising a handle portion to be gripped by a worker, and a drive portion capable of driving wheels with electric power, the walking type electric transporter to be coupled to a trolley on which cargo is mounted to be capable of electrically towing or pushing back, the walking type electric transporter further comprising:
a transporter main body portion including the drive portion and the wheels;
a standing portion standing upward from the transporter main body portion and including the handle portion at an upper end; and
a storage battery that supplies the electric power to the drive portion,
wherein the storage battery is accommodated in a box-shaped battery casing, and the battery casing is detachably attached to the transporter main body portion, and
wherein the battery casing holds the storage battery while having a space in such a manner that an upper portion and a front portion in an interior and an upper surface and a front surface of the storage battery are respectively separated from each other.

2. The walking type electric transporter according to claim 1,
wherein the transporter main body portion includes a case in which the drive portion is accommodated, and a surrounding portion provided in a periphery while being separated from the case, and
wherein the battery casing is supported by the surrounding portion.

3. The walking type electric transporter according to claim 2,
wherein a mounting plate having a shape along a shape of a lower portion of the battery casing is attached on the upper side of the surrounding portion, and the battery casing is supported in a state of concavo-convex engagement with the mounting plate.

4. The walking type electric transporter according to claim 1,
wherein on the back surface side of the battery casing, guiding convex streaks placed across the standing portion of the transporter main body portion on the left and right sides are formed while being separated from each other in the left and right direction.

5. The walking type electric transporter according to claim 1,
wherein the battery casing holds the storage battery while having a space in such a manner that both side portions in the interior and both side surfaces of the storage battery are respectively separated from each other.

6. The walking type electric transporter according to claim 1,
wherein the battery casing is configured into a box shape by a front plate, a rear plate, and an endless tubular body nipped by the front plate and the rear plate.

7. The walking type electric transporter according to claim 6, having a bent groove portion in an upper portion of a front surface of the front plate of the battery casing,
wherein the groove portion has a shape in which a central portion in the left and right direction is convex downward.

8. The walking type electric transporter according to claim 6,
wherein the tubular body is corrugated.

9. The walking type electric transporter according to claim 2,
wherein on the back surface side of the battery casing, guiding convex streaks placed across the standing portion of the transporter main body portion on the left and right sides are formed while being separated from each other in the left and right direction.

10. The walking type electric transporter according to claim 2,
wherein the battery casing holds the storage battery while having a space in such a manner that both side portions in the interior and both side surfaces of the storage battery are respectively separated from each other.

11. The walking type electric transporter according to claim 2,
wherein the battery casing is configured into a box shape by a front plate, a rear plate, and an endless tubular body nipped by the front plate and the rear plate.

12. The walking type electric transporter according to claim 11, having a bent groove portion in an upper portion of a front surface of the front plate of the battery casing,
wherein the groove portion has a shape in which a central portion in the left and right direction is convex downward.

13. The walking type electric transporter according to claim 11,
wherein the tubular body is corrugated.

14. The walking type electric transporter according to claim 3,
wherein on the back surface side of the battery casing, guiding convex streaks placed across the standing portion of the transporter main body portion on the left and right sides are formed while being separated from each other in the left and right direction.

15. The walking type electric transporter according to claim 3,
wherein the battery casing holds the storage battery while having a space in such a manner that both side portions in the interior and both side surfaces of the storage battery are respectively separated from each other.

16. The walking type electric transporter according to claim 3,
wherein the battery casing is configured into a box shape by a front plate, a rear plate, and an endless tubular body nipped by the front plate and the rear plate.

17. The walking type electric transporter according to claim 16, having a bent groove portion in an upper portion of a front surface of the front plate of the battery casing,
wherein the groove portion has a shape in which a central portion in the left and right direction is convex downward.

18. The walking type electric transporter according to claim 17,
wherein the tubular body is corrugated.

19. The walking type electric transporter according to claim 7,
wherein the tubular body is corrugated.

20. The walking type electric transporter according to claim 12,
wherein the tubular body is corrugated.
